(19) United States
(12) Patent Application Publication
(10) Pub. No.: US 2014/0071907 A1
(43) Pub. Date: Mar. 13, 2014

(54) Method and Apparatus for Handling PDN Connections

(71) Applicant: Telefonaktiebolaget L M Ericsson (publ), Stockholm (SE)

(72) Inventors: Dinand Roeland, Sollentuna (SE); Zoltán Richárd Turányi, Szentendre (HU)

(73) Assignee: Telefonaktiebolaget L M Ericsson (publ), Stockholm (SE)

(21) Appl. No.: 13/976,209

(22) PCT Filed: May 3, 2013
(86) PCT No.: PCT/EP2013/059288

§ 371 Date: Aug. 28, 2013

Related U.S. Application Data
(60) Provisional application No. 61/642,527, filed on May 4, 2012.

(51) Int. Cl. H04W 76/02

(52) U.S. Cl. CPC H04W 76/021
USPC 370/329

(57) ABSTRACT

A method and apparatus for handling Packet Data Network (PDN) connections between a 3GPP core network node and a User Equipment (UE) via a non-3GPP access network. The UE sends to a gateway node in the non-3GPP access network a first message requesting establishment of a PDN connection. The UE obtains a key associated with the PDN connection and subsequently sends to the gateway node data packets relating to the PDN connection, each data packet including the key. The key allows the gateway node to identify the PDN connection even when multiple PDN connections are used by the UE.

### TECHNICAL FIELD

The present disclosure relates to the field of handling PDN connections between a User Equipment and a 3GPP core network node via a non-3GPP access network.

### BACKGROUND

The Third Generation Project Partnership (3GPP) has developed the System Architecture Evolution (SAE) as the core network architecture of its future and Long Term Evolution (LTE) wireless mobile telecommunications standard. The main component of the SAE architecture is the Evolved Packet Core (EPC; see “Architecture enhancements for non-3GPP Accesses,” 3GPP TS 23.402). The LTE/SAE network includes network entities supporting the user and control planes.

An ongoing trend within telecommunications is the convergence of fixed and mobile networks, which is known as Fixed Mobile Convergence (FMC). The trend of evolving networks using IP-based technologies is common for fixed and mobile networks, which makes the convergence easier. By FMC, mobile and fixed network operators will be able to utilize their network resource more efficiently, which leads to reduction of capital and operational expenditure (CAPEX and OPEX). For instance, when a user is running an IP-based application such as Multimedia Telephony (MMTeI) inside their home, it is more efficient to utilize broadband connectivity of the fixed access network rather than the wireless access network.

Residential networks have been important to the success of FMC because they are the most commonly used fixed network access by ordinary users. Therefore, it is important to be able to connect mobile phones to the EPC through a residential network. The term User Equipment (UE) can be used in place of the term mobile terminal or mobile phone. The term UE is familiar in the 3GPP documentation, and is intended to refer to any piece of equipment that is configured to access the internet; it would include, for example and without limitation, mobile telecommunication devices, portable or handheld computing devices and desktop or installed computers.

3GPP defines mobile 2G/3G/LTE accesses and “non-3GPP accesses” (TS 23.402). The latter can be a fixed network. The BBF (BroadBand Forum, the standardization organization for the fixed access; see http://www.broadband-forum.org/) defines an architecture for fixed networks. Many UEs address the FMC trend by providing multiple radio interfaces: one interface to connect to a 2G/3G/LTE access and a WiFi interface to connect to a fixed network.

In the WiFi Alliance, one of the focus areas is (public) hotspots. Therefore, in addition to the residential networks described above, hotspots are increasingly becoming important to the success of FMC.

A 3GPP UE can attach to a non-3GPP access network (e.g. a fixed network) and connect to one or more Packet Data Networks (PDNs) via the S2 interface (3GPP TS 23.402]. There are three types of S2 interface: S2a, S2b and S2c. The latter two overlay the non-3GPP access network and do not impact it. S2a is a more converged solution that does impact nodes in the non-3GPP access network. In S2a, the non-3GPP access network is seen as trusted; the non-3GPP access network is therefore denoted as TNAN (Trusted Non-3GPP Access Network). Where the TNAN uses Wireless LAN (WLAN) as the radio technology towards the UEs, the TNAN is denoted as TWAN (Trusted WLAN Access Network).

S2a over TWAN is now standardized in 3GPP (Chapter 16 of 3GPP TS 23.402). At present (3GPP Release 11), S2a over TWAN is restricted to support only a single PDN connection per UE. Also, the UE cannot indicate an Access Point Name (APN) and handover is not supported. This way, S2a over TWAN does not impose any requirements on the UE; in other words, an “unmodified UE” can be used, which increases time-to-market for the S2a solution.

FIG. 1 of the accompanying drawings is a schematic block diagram providing an architecture overview, illustrating a UE 2 connecting to a 3GPP domain 4 via a TWAN 6. The TWAN 6 comprises a Residential Gateway (RG) 8, an Access Node (AN) 10 and a gateway node denoted as a TWAN Access Gateway (TWAG) 12. The 3GPP domain 4 comprises one or more PDN Gateways (PGWs) 14.

In S2a, there is a GPRS Tunnelling Protocol (GTP) or Proxy Mobile IP (PMIP) tunnel for each PDN connection between the TWAG 12 (e.g. a BBF Border Network Gateway (BNG)) in the TWAN 6 and the 3GPP PGW(s). Each PDN connection is anchored in a 3GPP PGW. The UE receives one IP address for each PDN connection, and it is the PGW that assigns the address. Similarly, between the UE 2 and the TWAG 12 a point-to-point link is provided in order to separate the traffic from the different UEs and PDN connections.

A point-to-point link can be considered to be a protocol that provides a logical direct connection between two networking nodes. A data frame sent from node A via a point-to-point link to node B will not pass a node C. Note that a “point-to-point link” is a logical concept and can be implemented in several ways. The network between the UE 2 and the TWAG 12 would generally be Ethernet based, and examples of a point-to-point link between the UE 2 and TWAG 12 are: a L3 tunnel (e.g. IPsec or IP-in-IP), and a L2 tunnel (e.g. L2TP); however the technique disclosed herein is applicable to any data link layer or delivery protocol as will become apparent.

The per-UE point-to-point link works satisfactorily in 3GPP Release 11 when there is a restriction on a single PDN connection per UE over TWAN.

A situation may arise where a set of one or more PGWs assign the same IP address for different PDN connections. This could occur where, for example, there are two PDNs connections relating respectively to two closed corporate networks, each with their own addressing scheme. Each PDN might be served by a different PGW, and each PGW might be managed by a different operator. The 3GPP domain(s) and the UE are designed to handle such an overlap without any issue. However, the problem is that the TWAG will get confused; it will no longer be able to map upstream traffic to the correct GTP/PMIP tunnel.

It should be noted that the likelihood of such a problem occurring in a real deployment is small; most UEs will only use a single PDN connection, and the IP addressing schemes of different PDNs will in most cases not overlap. However, the problem can and will occur without a solution, and the present applicant has appreciated the desirability of addressing this issue.

There are typically two scenarios where such a problem of overlapping or clashing addresses when a UE access a 3GPP core network via a non-3GPP access network can arise. In both scenarios, a dual-radio UE is assumed; the UE has one radio interface for the 3GPP access (e.g. LTE), and one radio interface for the non-3GPP access (e.g. WiFi).

A first scenario is illustrated schematically in FIG. 2 of the accompanying drawings. In the first scenario, the UE 2 is initially connected to a 3GPP access 16, and already has overlapping addresses in the 3GPP access 16, or has an address in the 3GPP access 16 which overlaps with an address already assigned in the non-3GPP access 6. As mentioned previously, overlapping addresses in the 3GPP access 16 presents no problem; 3GPP by design allows for such a situation. However, a problem occurs when the UE 2 now does a handover to the non-3GPP access 6. This can be considered as the first scenario.

In a second scenario, the UE 2 is attached to a non-3GPP access 6 and opens a new PDN connection. The new address for that PDN connection overlaps with an existing address in the second scenario.

In release 11, a per-UE point-to-point link between the UE and the TWAG is assumed. In most cases, the UE IP address in a packet's header will be sufficient to correlate that packet to an individual PDN connection. However, there are a few situations where this is not possible:

(a) Two or more PDN connections from one UE might have the same IP address. This is in particular possible if these PDN connections are towards different IPv4 PDNs.

(b) Downlink (link layer) broadcasts do not include a specific UE target IP address. An example of such packet is an IPv6 router advertisement.

(c) Uplink (link layer) broadcasts do not include a specific UE source IP address. Such packets are for example used for service discovery.

(d) Downlink IP multicast does not include a specific UE target IP address. Such packets may for example be sent from a server in a PDN.

It has also been previously proposed to remove completely the notion of multiple PDN connections in the UE, and leave it up to the network to route traffic to different PDNs. One example of such solution is disclosed in IETF Internet-Draft “Multiple APN Support for Trusted Wireless LAN Access”, draft-gundavelli-netext-multiple-apn-pmipv6-01, available at http://datatracker.ietf.org/doc/draft-gundavelli-netext-multiple-apn-pmipv6. However, such a solution can be considered to break the current 3GPP architecture.

The present applicant has appreciated the desirability of addressing the above-identified issues.

### SUMMARY

It is mentioned above that, in order to support multiple PDN connections per UE over TWAN, it has been previously considered to maintain a single point-to-point link per UE. An alternative to this is to have a point-to-point link per UE-and-PDN-connection. S2b and S2c use this approach by implementing the per-PDN point-to-point link with an IP tunnel. A tunnel mechanism is proposed herein for a non-3GPP radio access (e.g. WiFi) which is not based on IP as such.

A method is proposed here relating to the connecting of a mobile terminal or UE to a 3GPP core network, such as the Evolved Packet Core, via a non-3GPP access network. The method finds use in a Fixed Mobile Convergence scheme, for example where the mobile terminal or UE connects to the 3GPP core network through a fixed residential network, for example using WiFi.

The applicant has appreciated that an extension is needed to support multiple PDN connections per UE. It is an object to provide a mechanism whereby a UE can differentiate between multiple PDN connections.

According to a first aspect of the invention, there is provided a method of handling Packet Data Network (PDN) connections between a 3GPP core network node and a User Equipment (UE) via a non-3GPP access network. The UE sends to a gateway node in the non-3GPP access network a first message requesting establishment of a PDN connection. The UE obtains a key associated with the PDN connection and subsequently sends to the gateway node data packets relating to the PDN connection, each data packet including the key. An advantage of the key is that it allows the gateway node to identify the PDN connection even if multiple PDN connections are used by the UE

As an option, the UE receives S10 a data packet containing the key from the gateway node and correlates the key with the PDN connection, allowing the data packet to be correlated with the PDN connection. This ensures that data packets sent from the gateway node can be identified with the correct PDN by the UE.

The key is optionally generated by the UE and sent in the first message. Alternatively, the UE requests the key from the gateway node and receives the key in response.

Each data packet comprises a header identifying the key associated with the PDN connection. The payload of each data packet may be encapsulated using an intermediate protocol, the header further identifying the intermediate protocol. Furthermore, a tunnel may be established between the UE and the gateway node.

Examples of gateway nodes are a Trusted WLAN Access Network Access Gateway, a Broadband Forum node and a Border Gateway Node. An example of a 3GPP core network node is a Packet Data Network Gateway.

According to a second aspect of the invention, there is provided a method of handling PDN connections between a 3GPP core network node and a UE via a non-3GPP access network. A gateway node in the non-3GPP access network receives a first message requesting establishment of a PDN connection from the UE. The gateway node establishes the PDN connection between the 3GPP core network node and the UE. It also obtains a key associated with the PDN connection, and associates the PDN connection with the key. This allows it to correctly associate packets sent between the UE and the 3GPP core network node with the correct PDN.

As an option, the gateway node receives from the UE a data packet that includes key. On the basis of the key, the gateway node determines a tunnel associated with the PDN connection and sends the data packet towards the 3GPP core network node using the tunnel.

The gateway node optionally receives via a tunnel from the 3GPP core network node a data packet sent towards the UE. On the basis of an identity of the tunnel, the gateway node determines the key associated with the PDN connection and sends the data packet towards the UE using a further tunnel associated with the key.

The gateway node optionally receives the key in the first message from the UE. Alternatively, the gateway node generates the key after receiving the request to establish the PDN connection and sends the key to the UE.

The gateway node optionally associates the key with an identifier relating to the UE, thereby allowing the gateway node to identify the PDN connection and the associated UE from a plurality of UEs. This ensures that no collisions occur if two or more UEs use the same key to identify a PDN connection associated with each UE.

According to a third aspect of the invention, there is provided a UE that has a transmitter for sending to a gateway node in a non-3GPP access network a first message requesting establishment of a PDN connection between a 3GPP core network node and the UE. A processor obtains a key associated with the PDN connection, and the transmitter is further arranged to send, to the gateway node, data packets relating to the PDN connection, each data packet including the key.

The UE optionally includes a receiver for receiving a data packet from the gateway node. The processor is arranged to obtain a key from the data packet and correlate the key with the PDN connection, allowing the data packet to be correlated with the PDN connection.

The processor is optionally arranged to generate the key, and the transmitter is arranged to send the key in the first message. Alternatively, the transmitter may send a request for the key, and the receiver may receive the key from the gateway node.

As an option, the processor is arranged to encapsulate a payload of each data packet using an intermediate protocol, a header further identifying the intermediate protocol.

The processor is optionally arranged to establish a tunnel between the UE and the gateway node using the intermediate protocol.

According to a fourth aspect of the invention, there is provided a gateway node for use in a non-3GPP access network. The gateway node is provided with a receiver for receiving from a UE a first message requesting establishment of a PDN connection between the UE and a 3GPP core network node. A processor is provided for arranging the establishment of the PDN connection between the 3GPP core network node and the UE. The processor is also arranged to obtain a key associated with the PDN connection. An advantage of this is that the key can be used to identify the PDN connection even where a UE has multiple PDN connections.

The receiver is optionally arranged to receive from the UE a data packet, the data packet including the key. The processor, on the basis of the key, determines a tunnel associated with the PDN connection. A transmitter is also provided for sending the data packet towards the 3GPP core network node using the tunnel.

The gateway node is optionally provided with a second receiver for receiving via a tunnel from the 3GPP core network node, a data packet sent towards the UE. The processor is arranged to, on the basis of an identity of the tunnel, determine the key associated with the PDN connection. A second transmitter is provided for sending the data packet towards the UE using a further tunnel associated with the key.

The processor is optionally arranged to generate the key; and a second transmitter is arranged to send the key to the UE.

According to a fifth aspect of the invention, there is provided a computer program comprising computer readable code which, when run on a UE, causes the UE to perform the method as described above in the first aspect.

According to a sixth aspect, there is provided a computer program comprising computer readable code which, when run on a gateway node, causes the gateway node to perform the method as described above in the second aspect.

According to a seventh aspect, there is provided a computer program product comprising a non-transitory computer readable medium and a computer program as described above in either the fifth or sixth aspects, wherein the computer program is stored on the non-transitory computer readable medium.

According to the aspects described above, a UE can attach to a non-3GPP access network and connect to one or more PDNs via a 3GPP core network. Each PDN connection is anchored in a gateway node in the 3GPP core network (such as a PDN Gateway or PGW), and in a gateway node in the non-3GPP access network (such as a TWAG or border gateway node or BGW; in the case where a BBF network is the non-3GPP access network, the BGW might be a BNG). A separate tunnel is established for each such PDN connection between the gateway node (e.g. TWAG, BGW or BNG) in the non-3GPP access network and the gateway node (e.g. PGW) in the 3GPP core network.

For brevity, the gateway node in the non-3GPP access network (e.g. TWAG, BGW or BNG) is referred to as the non-3GPP gateway node, and the gateway node in the 3GPP core network (e.g. PGW) is referred to as the 3GPP gateway node.

The UE receives an IP address for each PDN connection. In this respect, a PDN connection can be considered to be an association between an UE and a PDN, represented for example by one IPv4 address and/or one IPv6 prefix. It is the gateway node (e.g. PGW) in the 3GPP core network that assigns the address. A PDN is identified by an APN and a PDN is accessed via the PGW.

A method is particularly proposed here for use in establishing and/or using a plurality of packet data network or PDN connections between a UE and a 3GPP core network via a non-3GPP access network.

For a first PDN connection established between the UE and the 3GPP core network via the non-3GPP access network, a payload is communicated over the non-3GPP access network within a packet in which a delivery protocol associated with the non-3GPP access network is used to encapsulate a payload protocol. The payload protocol is used for carrying the payload. The payload protocol can be considered to be associated with the end hosts (i.e. UE and its peer in the PDN) or can alternatively be considered to be associated with the PDN. The packet comprises a header associated with the delivery protocol, followed by a header associated with the payload protocol, followed by the payload. The delivery protocol header may comprise an indication of the type of payload protocol.

The UE and the 3GPP gateway node would each perform the steps of forming such a packet and sending the packet to the 3GPP gateway node or the UE respectively.

For a subsequent PDN connection established between the UE and the 3GPP core network via the non-3GPP access network, a payload is communicated over the non-3GPP access network within a packet in which the delivery protocol is used to encapsulate an intermediate protocol which itself is used to encapsulate the payload protocol, the payload protocol being used for carrying the payload. The packet comprises a header associated with the delivery protocol, followed by a header associated with the intermediate protocol, followed by a header associated with the payload protocol, followed by the payload.

The intermediate protocol header comprises a key used to differentiate between PDN connections of the plurality of PDN connections. A different key is used for each PDN connection of the plurality, or at least for the second and subsequent PDN connections of the plurality, to distinguish between the PDN connections or to allow such a distinction to be made.

The key is unique within the scope of the UE to enable different PDN connections for that UE to be distinguished by the UE. A combination of the key with a further key which is unique to the UE therefore provides a globally unique identification of a PDN connection to allow a network node to differentiate any PDN connection from any UE to another PDN connection from another UE.

Such an approach provides an S2a-based solution that differentiates from S2b. It provides full backwards compatibility to 3GPP Release 11. Providing support for multiple PDN connections can be made fully optional. It provides a clean, tunnelled approach for additional PDN connections. Handover of each individual PDN connection can be performed, including the first.

Although it is described above that the use of an intermediate protocol only for the second and subsequent PDN connections, it will be appreciated that the intermediate protocol concept can also be applied to all PDN connections including the first, particularly if backwards compatibility is not required for single PDN connection use cases and terminals.

The delivery protocol header may comprise an indication of the type of intermediate protocol. The intermediate protocol header may comprise an indication of the type of payload protocol.

The UE and the non-3GPP gateway node each and separately perform the step of setting up a tunnel associated with the intermediate protocol between the UE and the non-3GPP gateway node.

The UE and the non-3GPP gateway node each and separately perform the steps of forming such a packet and sending the packet to the non-3GPP gateway node or the UE respectively over the established tunnel.

The delivery protocol may be Ethernet-based. In such a case, the above-mentioned further key may be the MAC address of the UE. Also in such a case, the delivery protocol header may comprise respective MAC addresses of the source and destination devices (UE or gateway node in the non-3GPP access network). The above-mentioned point-to-point connection may be an L2 or Ethernet connection.

The intermediate protocol may be any suitable protocol.

The payload protocol may be IP, and perhaps most commonly would be IP.

As part of the tunnel setup procedure or separately, the non-3GPP gateway node sends a message (e.g. PDN connection request) to the 3GPP gateway node.

The PDN connection request is accepted by the 3GPP core network. The 3GPP gateway node allocates to the UE an address associated with the payload protocol and sends it in a response message to the non-3GPP gateway node.

Then the non-3GPP gateway node completes the tunnel setup procedure and sends the UE a triggering response message including the allocated IP address.

The steps performed at the non-3GPP access network may be performed by a gateway node of the non-3GPP access network, and the steps performed at the 3GPP core network may be performed by a gateway node of the 3GPP core network.

The non-3GPP access network may be a BroadBand Forum, BBF, network.

The non-3GPP gateway node may be a Border Network Gateway node of the BBF network.

The non-3GPP access network may be an access network defined by the WiFi Alliance. The non-3GPP access network may in certain architectures be considered to form part of the 3GPP access network.

The 3GPP gateway node may be a PDN Gateway node of the 3GPP core network.

Further information will now be provided about the structure of the packet referred to above. The packet carries a payload being communicated over the non-3GPP access network. The above-mentioned delivery protocol is used to encapsulate the above-mentioned intermediate protocol which itself is used to encapsulate the above-mentioned payload protocol, with the payload protocol being used to carry the payload. The packet can therefore be considered to be delivered through an intermediate protocol tunnel (a tunnel associated with the intermediate protocol) between the UE and the non-3GPP gateway node. The packet comprises a header associated with the delivery protocol, followed by a header associated with the intermediate protocol, followed by a header associated with the payload protocol, followed by the payload. The key is generally provided within the header associated with the intermediate protocol header. As mentioned above, the key is used to differentiate between PDN connections of the plurality of PDN connections. A different key is used for each PDN connection of the plurality, or at least for the second and subsequent PDN connections of the plurality, to distinguish between the PDN connections or to allow such a distinction to be made.

### BRIEF DESCRIPTION OF THE DRAWINGS

FIG. 1 illustrates schematically in a block diagram a network architecture overview in which point-to-point links are provided between UE and TWAG, and tunnels between TWAG and PGW;

FIG. 2 illustrates schematically in a block diagram a UE handing over three PDN connections from a 3GPP access to a non-3GPP access;

FIG. 3 is a flowchart illustrating schematically an exemplary method;

FIG. 4 is a flowchart illustrating schematically a method;

FIG. 5 illustrates schematically in a block diagram exemplary apparatus;

FIG. 6 illustrates a frame format for a first PDN connection;

FIG. 7 illustrates a frame format for a second (and subsequent) PDN connection;

FIG. 8 is an illustrative diagram showing a UE attaching to a first and subsequent PDN connection;

FIG. 9 illustrates schematically in a block diagram an exemplary User Equipment;

FIG. 10 illustrates schematically in a block diagram an exemplary non-3GPP node;

FIG. 11 is a schematic illustration of an architecture having separate 3GPP and non-3GPP access networks;

FIG. 12 is a schematic illustration of an alternative architecture in which the non-3GPP access network is incorporated into the 3GPP access network; and

FIG. 13 is a schematic illustration of an alternative architecture in which the non-3GPP access network is incorporated into the 3GPP access network.

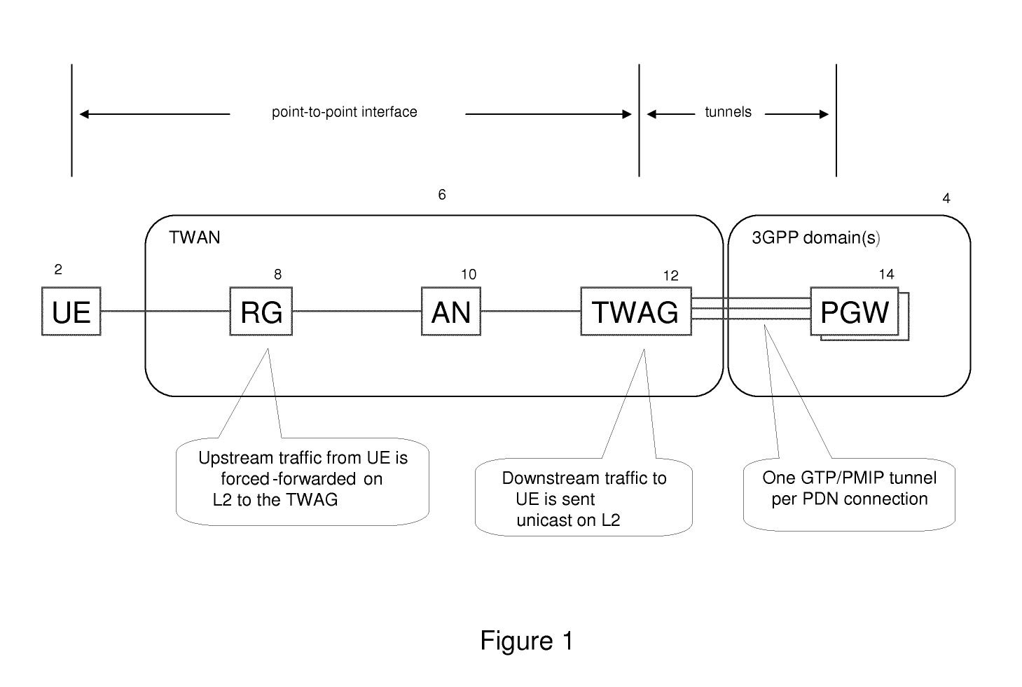

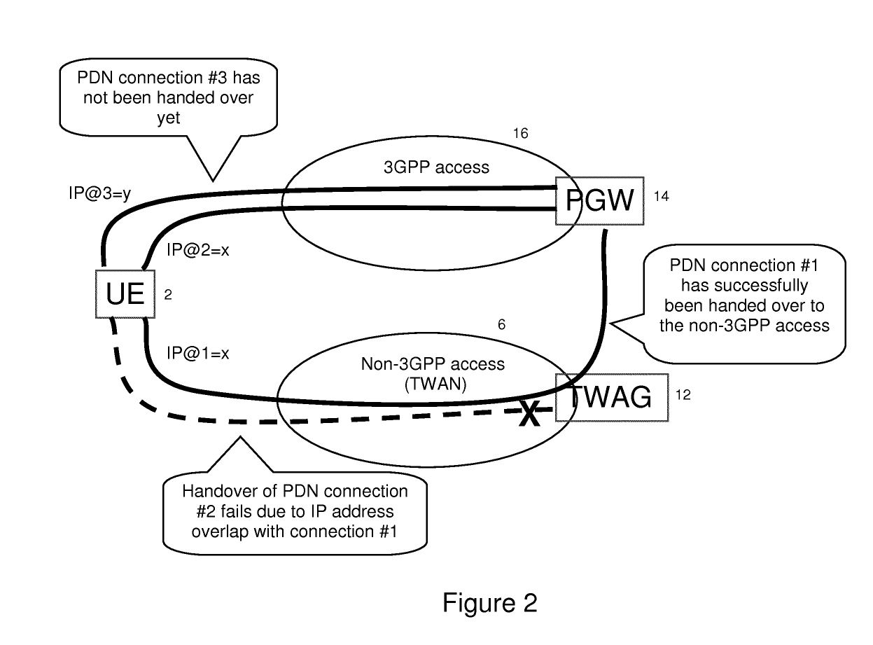

### DETAILED DESCRIPTION

As mentioned above, and in the case where Ethernet is used as the delivery protocol in the non-3GPP access network and IP is used as the payload protocol, the basic concept is to differentiate packets travelling on different PDN connections by inserting a small extra header (associated with the above-mentioned intermediate protocol) between the IP and Ethernet headers. Such a new header carries the identification of the PDN connection and is identified by an EtherType value. Packets on the first (default) PDN connection are generally transmitted without this header; this enables direct backwards compatibility with the case of single PDN connection use cases and terminals. It will be appreciated that delivery protocols other than Ethernet protocols can also use the same concept.

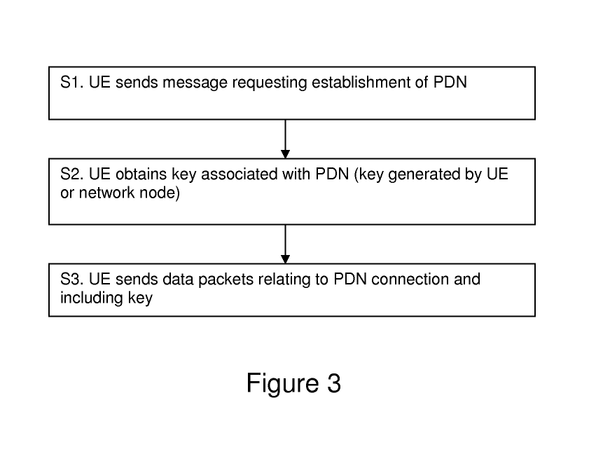

FIG. 3 is a flow diagram summarizing a method. The following numbering corresponds to that of FIG. 3:

S1. A User Equipment (UE) sends a message to a gateway node in a non-3GPP access network, the message requesting establishment of a PDN connection between the UE and 3GPP core network node.

S2. The UE obtains a key associated with the PDN. The UE may generate the key itself, and include the key in the message sent in step S1, or it may receive the key from the gateway node in response to the request to establish the PDN connection.

S3. Data packets subsequently sent to the gateway node include the key. This ensures that each data packet is associated with the correct PDN connection, even where the UE has established multiple PDN connections.

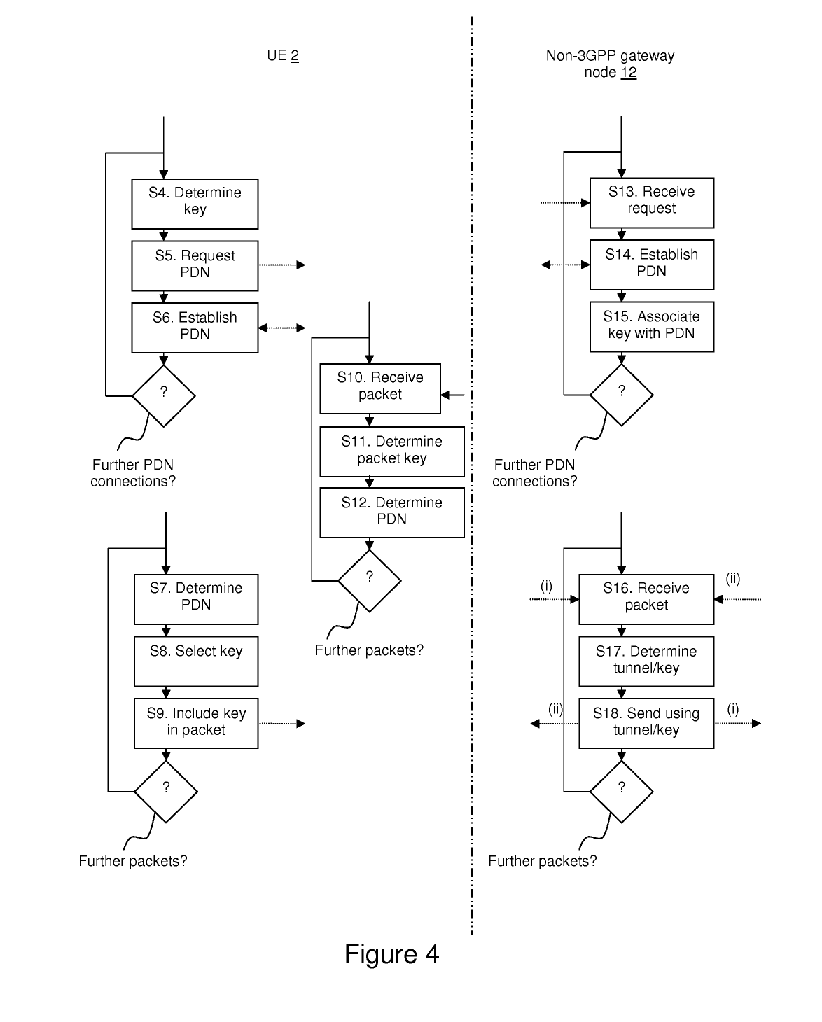

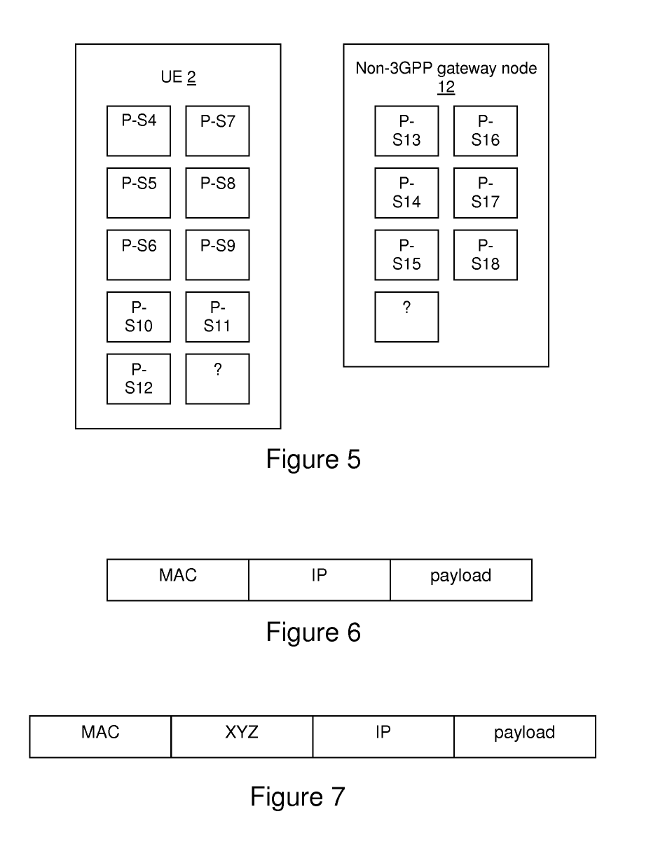

FIGS. 4 and 5 illustrate exemplary embodiments in which a UE 2 sets up a PDN connection with a non-3GPP Gateway node such as a TWAG 12. Steps performed at the UE 2 are illustrated in the schematic flowchart of FIG. 4 of the accompanying drawings. Corresponding parts or components or processors or transmitter/receivers P-S4 to P-S12 of a UE 2 for performing respective steps S4 to S12, are illustrated in FIG. 5 of the accompanying drawings.

For each of a plurality of PDN connections to be established between the UE 2 and a 3GPP core network via a gateway node in a non-3GPP access network, at least following the establishment of a first such PDN connection, the following steps are performed at the UE 2:

S4. A key is determined or received that is different to the key for any other PDN connection of the plurality. The key could be determined by the UE 2. Alternatively, where all PDN connections for a UE 2 are provided via the same non-3GPP gateway node, the UE 2 sends a request to the non-3GPP gateway node to provide a new key, and subsequently receive that key from the non-3GPP gateway node.

S5. A request to establish the PDN connection is sent to the gateway node 12 in the non-3GPP access network. This may include the key determined in step S4 or a reference or pointer to that key (e.g. where the key was provided by the gateway node in step S4). Alternatively, the key may be provided to the UE 2 after it has sent the request to establish the PDN.

S6. The PDN connection is established.

Once the PDN connections of the plurality have been established, for each of a plurality of data packets to be sent over a PDN connection of the plurality, the following steps are performed at the UE 2:

S7. Determine which PDN connection is to be used.

S8. Select the key appropriate to the PDN connection determined in S7.

S9. Include the key selected in S8 in the packet, and send the packet over the PDN connection. More information about this packet is provided below.

For each of a plurality of data packets received over a PDN connection of the plurality, the following steps are performed at the UE 2:

S10. Receive the packet (from the non-3GPP gateway node 12), including within it a key.

S11. Determine the key from the packet received in step S10. More information about this packet is provided below.

S12. Determine the PDN connection based on the key determined in step S11.

Steps performed at the gateway node 12 in the non-3GPP access network are illustrated in the schematic flowchart of FIG. 4 of the accompanying drawings. Corresponding parts or components or processors or transmitter/receivers P-S13 to P-S18 of a gateway node 12 in the non-3GPP access network, for performing respective steps S13 to S18, are illustrated in FIG. 5 of the accompanying drawings.

For each of a plurality of PDN connections to be established between the UE 2 and the 3GPP core network via the gateway node 12 in the non-3GPP access network, the following steps are performed at the gateway node:

S13. The request sent by the UE 2 in step S5 is received.

S14. The requested PDN connection is established. The PDN connection includes a tunnel (e.g. GTP or PMIP) between the gateway node 12 and a gateway node in the 3GPP core network, and a connection between the gateway node 12 and the UE 2. This involves communicating with the 3GPP core network to establish the tunnel for the PDN connection between the non-3GPP access network and the 3GPP core network and to assign an address associated with the payload protocol for the tunnel (the 3GPP core network is responsible for assigning such an address). The tunnel is associated with a PDN connection between the UE 2 and a PDN. Note that in an embodiment, the gateway node 12 generates the key once the request has been received and sends the key to the UE 2.

S15. The key is associated with the PDN connection.

Once the PDN connections of the plurality have been established, for each of a plurality of data packets to be sent over a PDN connection of the plurality, the following steps are performed at the gateway node 12 in the non-3GPP access network:

S16. Receive a packet.

S17(i). if the packet is received from a UE 2, determine the appropriate tunnel to be used based on the key in the packet; or

S17(ii). If the packet is received from the 3GPP core network through a tunnel, determine a key based on the tunnel through which the packet was received.

More information about the structure of this packet received in step S16 is provided below.

S18(i). in the case of S17(i) above, send the packet through the tunnel determined in step S17(i); or

S18(ii). in the case of S17(ii) above send the packet to a UE 2 over the connection appropriate to the key determined in step S17(ii).

Exemplary frame formats between UE 2 and TWAG 12 are shown in FIGS. 6 and 7. FIG. 6 illustrates a typical frame format for a first PDN connection. FIG. 7 illustrates a typical frame format for a second (and subsequent) PDN connection. The MAC header of the frames is as defined by IEEE 802.1. One field in the MAC part is the “EtherType”, which indicates the next header. For FIG. 6, the EtherType will be IP. For FIG. 7, the EtherType will be “XYZ”. Herein, “XYZ” is used as shorthand for the intermediate protocol which, as discussed below, can be any suitable protocol.

The XYZ header here includes the following two fields: (a) a key to differentiate the different PDN connections from each other; and (b) a next header indicator, which will be IP for this use case.

The key is unique within the scope of a single UE 2. The key combined with the MAC address of the UE 2 provides a globally unique identification for a PDN connection. The TWAG 12 can use this identification to correlate to the correct S2a tunnel.

Note that IP packets for all PDN connections (including the first) are carried in MAC frames between UE 2 and the TWAG 12. All MAC frames are carried within a per-UE point-to-point link between the UE 2 and the TWAG 12, as defined in Release 11 of 3GPP TS 23.402. With this approach, the idea proposed here is fully backwards compatible to Release 11.

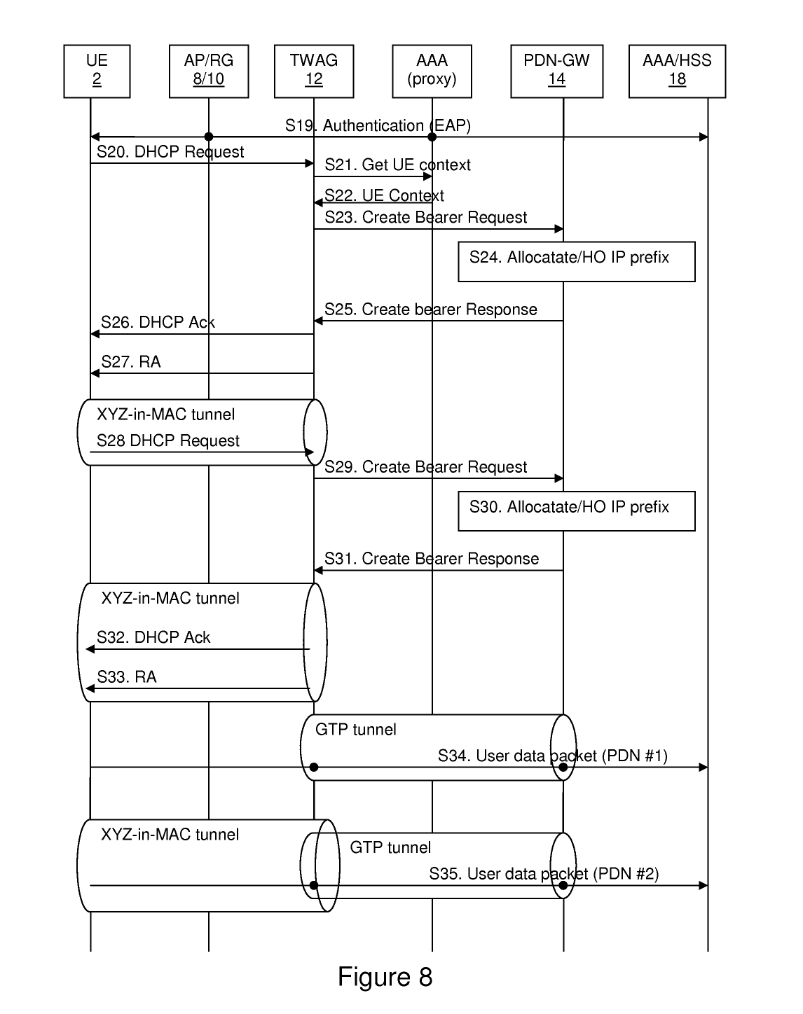

FIG. 8 shows a flow chart that outlines the signalling to set up multiple PDN connections. After authentication (S19), the UE 2 sends a Dynamic Host Configuration Protocol (DHCP) request (S20) which triggers the setup of the S2a tunnel for the first PDN connection (S21), as shown in steps S20 to S27. The UE 2 receives the IP@ of the first PDN connection in the DHCP reply (S26). Alternatively, in the case of IPv6, the prefix is sent to the UE 2 in a router advertisement (S27). Note that a DHCP Request is used as the trigger to establish the S2a tunnel. Alternatively, authentication (S19) may be used as the trigger; this is not shown in FIG. 8, as this feature is not central to the basic concept described above (see chapter 16.2.1 of 3GPP TS 23.402 for the two different trigger methods).

To set up a second PDN connection, the UE 2 sends a second DHCP Request (S28). Additional PDN connections may be set up; these would be a repetition of steps S28 to S33, and are therefore not shown in FIG. 8. Note that the message of S28 need not be a DHCP Request. DHCP has certain disadvantages, so the control protocol may be a protocol other than DHCP.

For the second PDN connection, IP packets for the UE 2 are carried on top of a tunnelling layer called “XYZ”, which is carried on top of Ethernet. Note that this assumes that the UE-TWAG communication (the delivery protocol) is Ethernet-based. This assumption is also made in 3GPP TS 23.402. However, the delivery protocol in other use cases need not be Ethernet-based; in this respect the term MAC address used herein is not intended to be limiting to any one particular standard or protocol, but is intended to cover any type of (supposedly unique) identifier for a device or a network interface relating to a device.

User data packets associated with the first PDN are sent from the UE 2 to the TWAG 12, and are then sent (S34) towards core network nodes in a GTP tunnel associated with the first PDN. User data packets associated with the second PDN are sent in the XYZ tunnel from the UE 2 to the TWAG 12, and then sent towards core network nodes in a further GTP tunnel associated with the second PDN.

The idea described above may be generalized in order to fit other use cases. For example, the use case above assumes that the XYZ tunnel carries an IP packet. However, the “next header” field in the XYZ header may just as well indicate a protocol other than IP (i.e. the payload protocol need not be IP). Also, a trusted WLAN access network is assumed above; however, the idea applies just as well to other access technologies, which could be wireless or wired.

The above-described concept of the key would generally be kept within the scope of the XYZ protocol, so that the DHCP message carried in the signal #11 is unaware of XYZ (and of the key). In step S28 of FIG. 8, therefore, XYZ carries an IP packet that happens to have DHCP as the payload. The XYZ header can be considered as a signal to the TWAG to set up a new XYZ tunnel. Again, note that the control protocol need not be DHCP but could be another control protocol.

DHCP may be used as trigger to setup the PDN connection. DHCP would in that scenario carry PDN-connection specific parameters like APN (a string indicating the name of the PDN).

Alternatively, XYZ may be used as trigger to setup the PDN connection. In that case, some XYZ control signal is needed to carry specific parameters relating to the PDN connection.

In this respect, FIG. 8 includes the parameters “HO” (handover indicator) and “APN” (APN string) in the DHCP exchanges (S20, S22, S23, S28 and S29). These parameters do not exist in current DHCP. There may be other alternatives to exchange such PDN-connection-specific parameters between UE and network. One alternative is to use extensions (e.g. vendor specific options) to 802.11u between the UE 2 and AP/RG 8/10, and some other protocol (e.g. RADIUS) between AP/RG 8/10 and other nodes in the TWAN 6. Another alternative is to add new parameters to the authentication signalling for the first PDN connection and add those parameters to XYZ for all other PDN connections. One way to implement this in XYZ is to indicate in the XYZ header (e.g. by means of a dedicated key) that control parameters are included after the XYZ header.

As mentioned above, XYZ (the intermediate protocol) can be any suitable protocol. A number of example candidates are:

(1) A new protocol could be defined. As the UE-TWAG interface spans across different Standardization Organizations (SDOs), it would be likely that one of these SDOs would do the detailed protocol definition. A new EtherType value would need to be applied for by IEEE.

(2) The IETF GRE protocol, in particular GRE-with-key (see Key and Sequence Number Extensions to GRE, available at http://tools.ietf.org/rfc/rfc2890.txt) would also be suitable. A new EtherType value would need to be applied for by IEEE.

(3) Point-to-Point Protocol over Ethernet (PPPoE) is another candidate. No new EtherType value is required. A possible disadvantage of PPPoE is that it is perceived as “legacy” in most fixed broadband deployments.

XYZ tunnel setup includes the preparation of the endpoints and the negotiation of the key. This may be done dynamically; e.g. PPPoE provides such a mechanism. Alternatively, a very simple approach is to let the UE 2 pick the key. If the TWAG 12 receives an unknown key, and the number maximum number of tunnels for this UE 2 has not been exceeded, then the TWAG 12 treats this as a new tunnel request.

It will be appreciated that operation of one or more of the above-described components can be provided in the form of one or more processors or processing units, which processing unit or units could be controlled or provided at least in part by a program operating on the device or apparatus. The function of several depicted components may in fact be performed by a single component. A single processor or processing unit may be arranged to perform the function of multiple components. Such an operating program can be stored on a computer-readable medium, or could, for example, be embodied in a signal such as a downloadable data signal provided from an Internet website. The disclosure is to be interpreted as covering an operating program by itself, or as a record on a carrier, or as a signal, or in any other form.

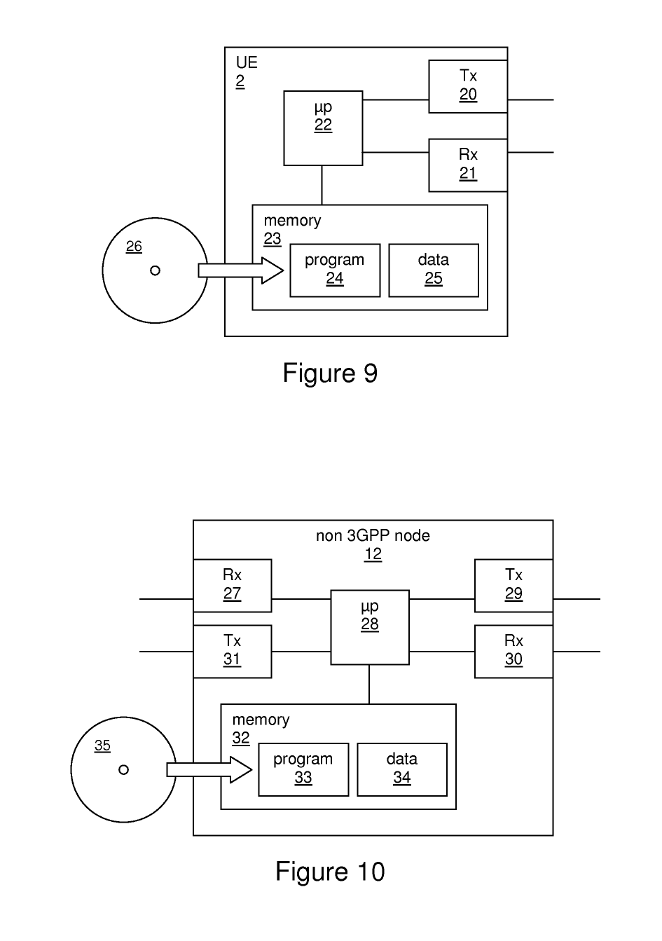

FIG. 9 illustrates an exemplary UE 2. The UE 2 is provided with a transmitter 20 for sending a request to the TWAG 12 to establish the PDN connection. As described above, the request may include the key associated with the PDN connection, in the embodiment in which the key is generated by the UE 2. The transmitter 20 is also arranged to send data packets including the key to the TWAG 12. A receiver 21 may be provided for receiving a data packet from the TWAG 12. In this case, a processor 22 obtains a key from the data packet and correlates the key with the PDN connection, allowing the data packet to be correlated with the correct PDN connection.

The processor 22 may be arranged to generate the key, or the transmitter 20 and receiver 21 may be arranged to obtain the key from the TWAG 12 in response to sending the request to establish the PDN connection.

The UE 2 may also be provided with a non-transitory computer readable medium in the form of a memory 23, which can be used to store a computer program 24. When executed by the processor 22, the computer program 24 causes the UE 2 to behave as described above. The memory 23 may also be used to store data, such as keys and the correlation of keys with PDN connections. Note that the computer program 24 may be obtained from a further non-transitory computer-readable medium in the form of a carrier medium 26 such as a flash drive or Compact Disk.

Note also that the description above refers to transmitters and receivers. These should be regarded as functional entities, and could be provided as different physical transmitters, receivers and transceivers in any suitable combination.

FIG. 10 illustrates schematically an exemplary non-3GPP node such as a TWAG 12. In this example, the TWAG 12 is provided with a receiver 27 for receiving from a UE a first message requesting establishment of the PDN connection between the UE 2 and the 3GPP node 14. This message may include a key associated with the PDN connection. A processor 28 is provided for arranging the establishment of the PDN connection between the 3GPP node 14 and the UE 2. The processor 28 is further arranged to associate the PDN connection with the key. If the first message does not include a key associated with the PDN connection, then the processor 28 may generate a key associated with the PDN and send the key to the UE 2.

For data sent from the UE 2 towards the 3GPP node 14, the receiver 27 subsequently receives a data packet from the UE that includes the key. The processor 28 is further arranged to, on the basis of the key, determine a tunnel associated with the PDN connection. A transmitter 29 is provided for sending the data packet towards the 3GPP node 14 using the tunnel.

For data sent from the 3GPP node 14 towards the UE 2, a second receiver 30 is provided for receiving via a tunnel from the 3GPP node 14, a data packet sent towards the UE 2. The processor 28 is arranged to, on the basis of an identity of the tunnel, determine the key associated with the PDN connection. A second transmitter 31 is provided for sending the data packet towards the UE 2 using a further tunnel associated with the key.

In the embodiment in which the TWAG 12 generates the key, this may performed by the processor 28 or a separate processor (not shown).

The TWAG 12 may be provided with a non-transitory computer-readable medium in the form of a memory 32. The memory 32 may be used to store a program 33 which, when executed by the processor 28, causes the TWAG 12 to behave as described above. The memory may also be used to store data, such as the identity of PDN connections and their associated keys. Note that the computer program 33 may be obtained from a further non-transitory computer-readable medium in the form of a carrier medium 35 such as a flash drive or Compact Disk.

Note also that the description of FIGS. 9 and 10 above refers to transmitters and receivers. These should be regarded as functional entities, and could be provided as different physical transmitters, receivers and transceivers in any suitable combination.

The appended signaling diagrams can be considered not only to depict a series of messages exchanged and method steps performed by the various nodes, but also to depict apparatus for exchanging those messages or performing those method steps. In addition, for the sake of completeness, any message which is shown or described as being sent from node A to node B implicitly includes the step of node A sending the message as well as the step of node B receiving the message, and means at nodes A and B for performing those steps.

It will be appreciated by the person of skill in the art that various modifications may be made to the above described embodiments without departing from the scope of the present disclosure. For example, it will be readily appreciated that although the above embodiments are described with reference to parts of a 3GPP core network, the technique described herein will also be applicable to like networks, such as a successor of the 3GPP core network, having like functional components. For example, the term UE is to be interpreted as covering any device. Likewise, the present disclosure is not to be understood as being restricted to any particular non-3GPP access network such as the BBF or an access defined by the WiFi Alliance, but is applicable to any non-3GPP access network. Therefore, in particular, the terms 3GPP and BBF or WiFi and associated or related terms used in the above description and in the appended drawings are to be interpreted accordingly.

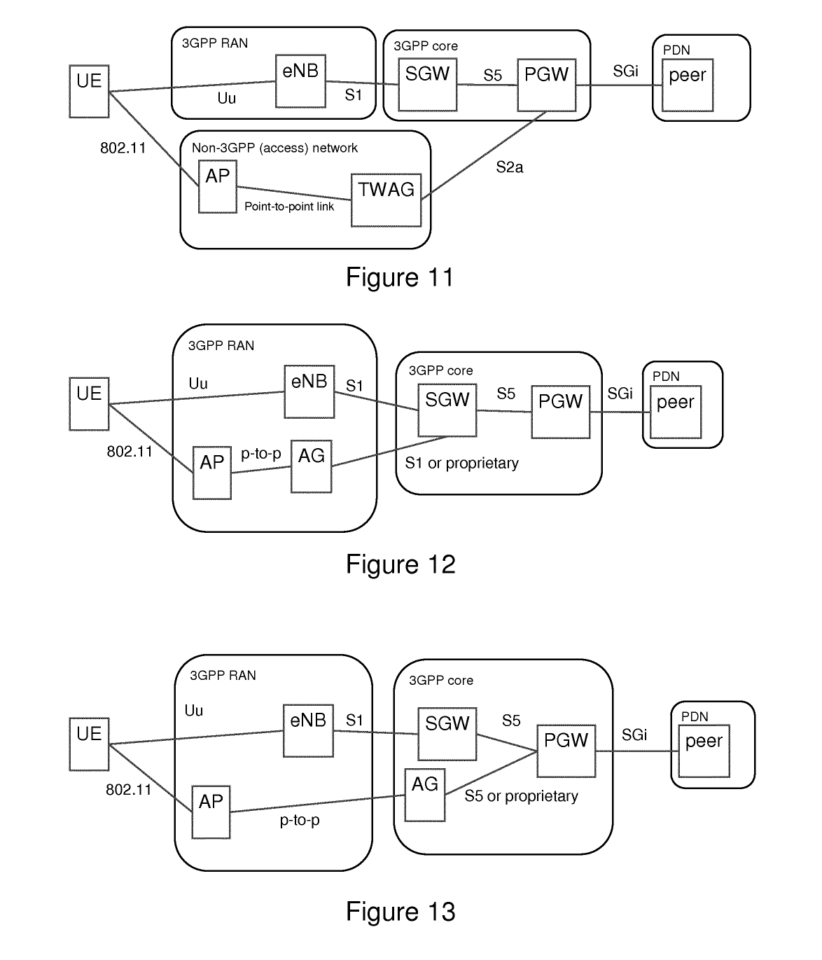

More particularly, it is to be appreciated that the FMC work started off with an architecture having a 3GPP core network and a separate non-3GPP access network such as is illustrated in FIG. 11. However, possibilities are now being considered to incorporate WiFi into the 3GPP radio access network, leading to the architectures illustrated in FIGS. 12 and 13.

In the architecture of FIG. 11, the TWAG (referred to as an AG or Access Gateway in FIG. 11) is now inside the 3GPP RAN. There is still a point-to-point link between the AP and TWAG, just as in FIG. 11. (Note that network nodes can generally be considered as functional entities, so that they may be split or co-located—e.g. the PGW and SGW may be co-located, the eNB and TWAG may be co-located, and so on.)

In the architecture of FIG. 13, the AG is now inside the 3GPP core. There is still a point-to-point link between AP and TWAG, just as previously.

It is important to appreciate that the techniques disclosed herein are equally applicable to the architectures of FIGS. 12 and 13, and therefore the term “non-3GPP access network” is to be interpreted accordingly, i.e. covering both a separate non-3GPP access network and a non-3GPP access network effectively incorporated into or considered in some sense as being part of the 3GPP access network. The non-3GPP access bypasses the 3GPP access provided by way of the eNodeB (eNB). Likewise, the term “non-3GPP gateway node” used herein is to be interpreted as covering the architecture of FIG. 13. As such, “gateway node in the non-3GPP access network” or “non-3GPP gateway node” can be substituted simply by “gateway node” where appropriate, and “non-3GPP access network” can be substituted simply by “access network” where appropriate.

The following abbreviations have been used in the above description:

3GPP Third Generation Project Partnership

AG Access Gateway

AN Access Node

APN Access Point Name

BBA BBF Access Interworking

BBF Broadband Forum

BNG BBF Border Network Gateway

CAPEX capital expenditure

DHCP Dynamic Host Configuration Protocol

eNB eNodeB

EPC Evolved Packet Core

FMC Fixed Mobile Convergence

GPRS General Packet Radio Service

GTP GPRS Tunnelling Protocol

HO handover

IPsec Internet Protocol Security

LTE Long Term Evolution

MMTeI Multimedia Telephony

OPEX operational expenditure

PDN Packet Data Networks

PGW PDN Gateway

PMIP Proxy Mobile IP

PPPoE Point-to-Point Protocol over Ethernet

RAN Radio Access Network

RG Residential Gateway

SAE System Architecture Evolution

TNAN Trusted Non-3GPP Access Network

TWAG TWAN Access Gateway

TWAN Trusted WLAN Access Network

UE User Equipment

WLAN Wireless LAN

1-30. (canceled)

31. A method of handling Packet Data Network (PDN) connections between a 3GPP core network node and a User Equipment via a non-3GPP access network, the method comprising:
the User Equipment sending a first message to a gateway node in the non-3GPP access network, the first message requesting establishment of a PDN connection;
the User Equipment obtaining a key associated with the PDN connection;
the User Equipment sending data packets relating to the PDN connection to the gateway node, each data packet including the key.

32. The method of claim 31, further comprising:
the User Equipment receiving a data packet from the gateway node;
the User Equipment obtaining a key from the data packet;
the User Equipment correlating the key with the PDN connection, allowing the data packet to be correlated with the PDN connection.

33. The method of claim 31, wherein the key is generated by the User Equipment and sent in the first message.

34. The method of claim 31, further comprising:
the User Equipment sending a request for the key to the gateway node;
the User Equipment receiving the key from gateway node.

35. The method of claim 31, wherein each data packet comprises a header identifying the key associated with the PDN connection.

36. The method of claim 35, further comprising encapsulating a payload of each data packet using an intermediate protocol, the header of each data packet further identifying the intermediate protocol.

37. The method of claim 35, further comprising establishing a tunnel between the User Equipment and the gateway node.

38. The method of claim 31, wherein the gateway node is a Trusted WLAN Access Network Access Gateway, a Broadband Forum node, or a Border Gateway Node.

39. The method of claim 31, wherein the 3GPP core network node is a Packet Data Network Gateway.

40. A method of handling Packet Data Network (PDN) connections between a 3GPP core network node and a User Equipment via a non-3GPP access network, the method comprising:
a gateway node in the non-3GPP access network receiving a first message from the User Equipment, the first message requesting establishment of a PDN connection;
the gateway node establishing the PDN connection between the 3GPP core network node and the User Equipment;
the gateway node obtaining a key associated with the PDN connection, and associating the PDN connection with the key.

41. The method of claim 40, further comprising the gateway node:
receiving a data packet from the User Equipment, the data packet including the key;
determining, based on the key, a tunnel associated with the PDN connection;
sending the data packet towards the 3GPP core network node using the tunnel.

42. The method of claim 40, further comprising the gateway node:
receiving, via a tunnel from the 3GPP core network node, a data packet sent towards the User Equipment;
determining, based on an identity of the tunnel, the key associated with the PDN connection;
sending the data packet towards the User Equipment using a further tunnel associated with the key.

43. The method of claim 40, further comprising the gateway node receiving the key in the first message.

44. The method of claim 40, further comprising the gateway node:
generating the key associated with the PDN connection after receiving the first message;
sending the key to the User Equipment.

45. The method of claim 40, further comprising the gateway node associating the key with an identifier relating to the User Equipment, thereby allowing the gateway node to identify the PDN connection and the associated User Equipment from a plurality of User Equipment.

46. A User Equipment for use in a communications network, the User Equipment comprising:
a transmitter configured to send a first message to a gateway node in a non-3GPP access network, the first message requesting establishment of a PDN connection between a 3GPP core network node and the User Equipment;
a processor configured to obtain a key associated with the PDN connection;
wherein the transmitter is further configured to send data packets relating to the PDN connection to the gateway node, each data packet including the key.

47. The User Equipment of claim 46, further comprising:
a receiver configured to receive a data packet from the gateway node;
wherein the processor is further configured to:
obtain a key from the data packet;
correlate the key with the PDN connection, allowing the data packet to be correlated with the PDN connection.

48. The User Equipment of claim 46:
wherein the processor is configured to generate the key;
wherein the transmitter is configured to send the key in the first message.

49. The User Equipment of claim 46:
wherein the transmitter is configured to send a request for the key to the gateway node;
wherein the receiver is configured to receive the key from gateway node.

50. The User Equipment of claim 49, wherein the processor is configured to encapsulate a payload of each data packet using an intermediate protocol such that a header of each data packet identifies the intermediate protocol.

51. The User Equipment of claim 50 wherein the processor is configured to establish a tunnel between the User Equipment and the gateway node using the intermediate protocol.

52. A gateway node for use in a non-3GPP access network, the gateway node comprising:
a receiver configured to receive a first message from a User Equipment, the first message requesting establishment of a PDN connection between the User Equipment and a 3GPP core network node;
a processor configured to:
arrange the establishment of the PDN connection between the 3GPP core network node and the User Equipment;
obtain a key associated with the PDN connection.

53. The gateway node of claim 52:
wherein the receiver is configured to receive a data packet from the User Equipment, the data packet including the key;
wherein the processor is further configured to determine, based on the key, a tunnel associated with the PDN connection;
further comprising a transmitter configured to send the data packet towards the 3GPP core network node using the tunnel.

54. The gateway node of claim 53:
further comprising a second receiver configured to receive, via a tunnel from the 3GPP core network node, a data packet sent towards the User Equipment;
wherein the processor is configured to determine, based on an identity of the tunnel, the key associated with the PDN connection;
further comprising a second transmitter configured to send the data packet towards the User Equipment using a further tunnel associated with the key.

55. The gateway node of claim 52:
wherein the processor is configured to generate the key;
further comprising a transmitter configured to send the key to the User Equipment.

56. The gateway node of claim 52, wherein the gateway node is a Trusted WLAN Access Network Access Gateway, a Broadband Forum node, or a Border Gateway Node.

57. A computer program product stored in a non-transitory computer readable medium for handling Packet Data Network (PDN) connections between a 3GPP core network node and a User Equipment via a non-3GPP access network, the computer program product comprising software instructions which, when run on the User Equipment, causes the User Equipment to:
send a first message to a gateway node in the non-3GPP access network, the first message requesting establishment of a PDN connection;
obtain a key associated with the PDN connection;
send data packets relating to the PDN connection to the gateway node, each data packet including the key.

58. A computer program product stored in a non-transitory computer readable medium for handling Packet Data Network (PDN) connections between a 3GPP core network node and a User Equipment via a non-3GPP access network, the computer program product comprising software instructions which, when run on a gateway node in the non-3GPP access network, causes the gateway node to:
receive a first message from the User Equipment, the first message requesting establishment of a PDN connection;
establish the PDN connection between the 3GPP core network node and the User Equipment;
obtain a key associated with the PDN connection, and associating the PDN connection with the key.
